(19) United States
(12) Patent Application Publication
(10) Pub. No.: US 2020/0240636 A1
(43) Pub. Date: Jul. 30, 2020

(54) SYSTEMS AND METHODS FOR FIRING AN INSULATOR

(71) Applicant: GRASIM INDUSTRIES LTD, Halol (IN)

(72) Inventors: Anupam Gupta, Halol (IN); Sushantakumar Padhy, Halol (IN); Sharad Mankar, Halol (IN); Niraj Kumar Tyagi, Halol (IN); Srikanth Kotta, Halol (IN); Pratik Parikh, Halol (IN); Sovan Khan, Halol (IN)

(73) Assignee: GRASIM INDUSTRIES LTD, Halol (IN)

(21) Appl. No.: 16/776,345

(22) Filed: Jan. 29, 2020

(30) Foreign Application Priority Data
Jan. 30, 2019 (IN) 201921003774

(51) Int. Cl. F23N 1/02; F27D 7/02; F27D 19/00; F23N 5/18

(52) U.S. Cl. CPC F23N 1/02; F27D 7/02; F27D 19/00; F23N 5/18; F23N 2237/02; F27D 2007/026; F27D 2019/0012; F23N 2005/185; F23N 2223/36; F23N 2005/181; F27D 2019/0009; F27D 2019/0018

(57) ABSTRACT

Systems and methods for firing an insulator is described. A kiln includes at least three zones on a wall of the kiln, a processing unit, and at least three PID controllers. The at least three zones have at least three burners arranged vertically. The processing unit determines firing ratio information for the at least three zones. Each of the PID controllers corresponds to a zone of the at least three zones. The at least three PID controllers control supply of gas and air to the at least three burners of the at least three zones based on the firing ratio information.

### FIELD

The present disclosure relates generally to insulator manufacturing. More specifically, the present disclosure relates to firing of insulators.

### BACKGROUND

Insulators, such as electro porcelain, are used for supporting and holding electrical conductors, for example, high tension wires or circuit breakers. The insulators are manufactured in various sizes and shapes and have been used for different applications accordingly. For example, a suspension type insulator is made of number of porcelain discs connected in series and are used to hold a conductor suspended at a bottom end of the series. A shackle insulator is used at an end of a distribution line or at a sharp turn. In another example, a bushing insulator is used in transformers for providing insulation between a line conductor and an earth potential.

For insulators to sustain longer under high stress conditions or under thermal shocks, they need to possess certain characteristics in terms of having high strength, considerable hardness and toughness, and good resistance to thermal shocks. Such characteristics are obtained by high quality manufacturing. Particularly, a stage of the manufacturing at which the insulator formed from a clay is subjected to heat treatment, commonly referred to as firing.

The insulators undergo firing for a duration of up to 96 hours or more. During the firing process, the insulator is subjected to different stages of heating with variations in temperature. A burning regime associated with the firing depends on several physical, physico-chemical, and chemical transformations, occurring in the electro porcelain body as a result of temperature changes. The firing process in insulator manufacturing having appropriately controlled parameters inside a kiln results in developing high quality insulators, more particularly, during an oxidation stage and/or a reduction stage of the firing process. Therefore, various parameters, such as atmosphere, temperature, etc., are required to be precisely maintained and are periodically changed for smooth transformation from one stage to another.

Generally, conventional kilns for firing the electro porcelain insulators are manually operated. However, it is difficult to maintain the desired parameters inside the kiln when operated manually manual operation of the kiln may affect the smooth transition of atmosphere inside the kiln when the firing process progresses from one stage to another. Further, manual intervention may result in human error. Due to human error, an incorrect carrying of firing process increases fuel consumption and may also degrade quality of the insulators. The increased fuel consumption increases the production cost of insulators. Furthermore, the degraded quality of insulators may increase the rejection rate of insulators or may result in failure or electric breakdown of insulators.

### SUMMARY

The present subject matter relates to systems and methods for firing an insulator. In accordance with an example implementation, a kiln for firing an insulator includes at least three zones of burners on a wall of the kiln. Each of the at least three zones have at least three burners arranged vertically. Further, the kiln includes a processing unit and at least three proportional-integral-derivative (PID) controllers where each of the PID controllers corresponds to a zone of the at least three zones. The processing unit determines firing ratio information for the at least three zones. The at least three PID controllers control supply of gas and air to the at least three burners of the at least three zones based on the firing ratio information.

For controlling the supply of gas and air to the at least three burners of the at least three zones, the at least three PID controllers receive firing ratio information from the processing unit. Thereafter, a predetermined amount of flow of gas and a predetermined amount of flow of air to be supplied to the at least three burners of the corresponding zones is determined based on the firing ratio information. Accordingly, the gas dampers and the air dampers, both individually provided for each zone of the at least three zones, are controlled to supply the predetermined amount of flow of gas and the predetermined amount of flow of air to the at least three burners of the corresponding zones.

In accordance with another example implementation, an arrangement of supply of gas and an arrangement of supply of air to the at least three burners of the at least three zones are symmetrical with respect to each other.

In accordance with another example implementation, each of the at least three PID controllers maintains parameters as indicated in the firing ratio information in a corresponding zone based on at least one of the following parameters: temperature of each zone of the at least three zones, flow of air to each zone of the at least three zones, flow of gas to each zone of the at least three zones, pressure of the kiln, flame detection, amount of carbon monoxide, and amount of oxygen.

### BRIEF DESCRIPTION OF DRAWINGS

The following detailed description references the drawings, wherein:

FIG. 1 illustrates a portion of a kiln for firing an insulator, according to an example implementation of the present subject matter.

FIG. 2 illustrates an arrangement of burners in the kiln, according to an example implementation of the present subject matter.

FIG. 3 illustrates a control system implemented for firing the insulator, according to an example implementation of the present subject matter.

FIG. 4 illustrates a temperature profile chart, according to an example implementation of the present subject matter.

FIG. 5 illustrates a method for firing an insulator, according to an example implementation of the present subject matter.

### DETAILED DESCRIPTION

The present subject matter describes systems and methods for firing an insulator. The systems and the methods of the present subject matter may maintain all the parameters inside a kiln during a firing process of an electro porcelain insulator, herein after referred to as insulator, and prevents human error by eliminating manual intervention.

In accordance with an example implementation of the present subject matter, a kiln includes at least three zones on a wall of the kiln, a processor, and at least three proportional-integral-derivative (PID) controllers. Each of the three zones has at least three burners arranged vertically. The processor determines a firing ratio information for the at least three zones. Each of the at least three PID controllers controls supply of air and gas to the at least three burners of a corresponding zone of the at least three zones based on the firing ratio information.

The systems and methods of the present subject matter control temperature, combustion ratio, and internal atmosphere of the kiln in a zone wise manner Therefore, desired parameters inside the kiln at any given stage of firing process are precisely maintained. Further, with such precise control, heat treatment of the insulator can be smoothly transitioned from one stage to another stage. As a result, risk of human error due to manual intervention is reduced and as well as the fuel consumption is also reduced.

The following detailed description refers to the accompanying drawings. Wherever possible, the same reference numbers are used in the drawings and the following description to refer to the same or similar parts. While several examples are described in the description, modifications, adaptations, and other implementations are possible. Accordingly, the following detailed description does not limit the disclosed examples. Instead, the proper scope of the disclosed examples may be defined by the appended claims.

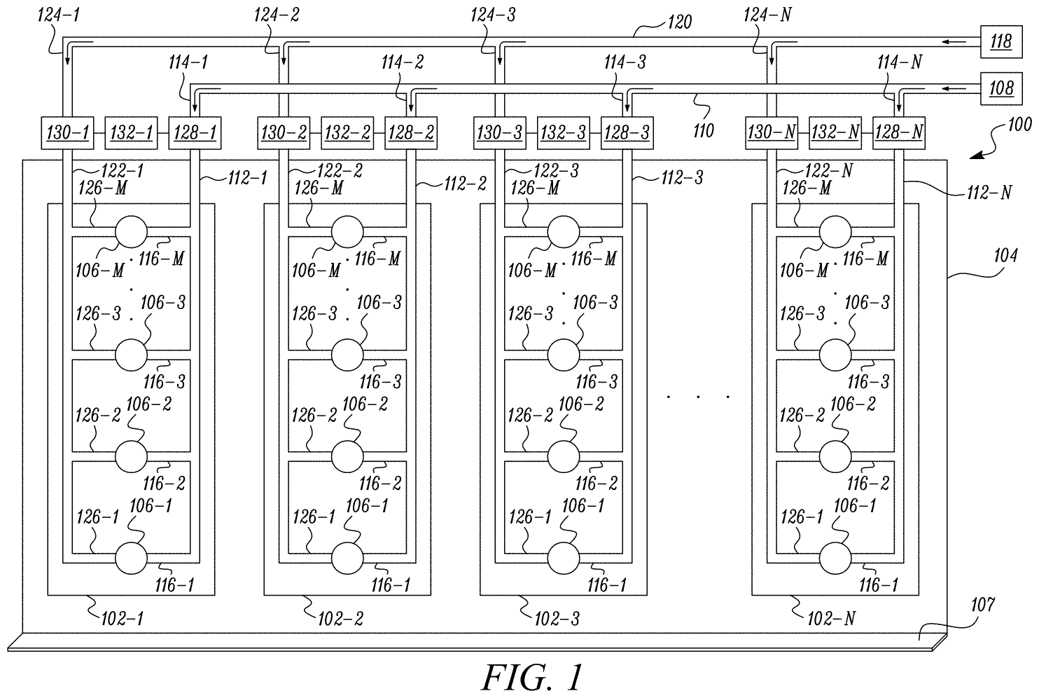

FIG. 1 illustrates a portion of a kiln 100 for firing an insulator, according to an example implementation of the present subject matter. The kiln 100 includes a plurality of zones, referenced by 102-1, 102-2, 102-3, . . . , 102-N, on a wall 104 of the kiln 100. Each zone 102 has a plurality of burners, referenced by 106-1, 106-2, . . . , 106-M. The burners 106 of the zones 102 are arranged vertically with respect to a base 107 of the kiln 100 and output flames away from the wall 104 and in a direction which is substantially perpendicular to the wall 104.

The insulator(s) to undergo firing process, in the kiln 100, is placed over the base 107. The insulator(s) may be placed directly over the base 107 or may be placed over the based 107 with an elevated height. The height elevation may be provided using a rigid or removable platform over the base 107. The insulator(s) placed over the base 107 undergo heat treatment by the flames produced by the burners 106 of the zones 102.

In an example implementation, the kiln 100 having a loading volume of up to 69 cubic meters may have three zones 102-1, 102-2, and 102-3 only, where each zone may have three burners. In another example implementation, the kiln 100 having loading volume above 69 cubic meters may have more than three zones, where each zone may have three or more than three burners.

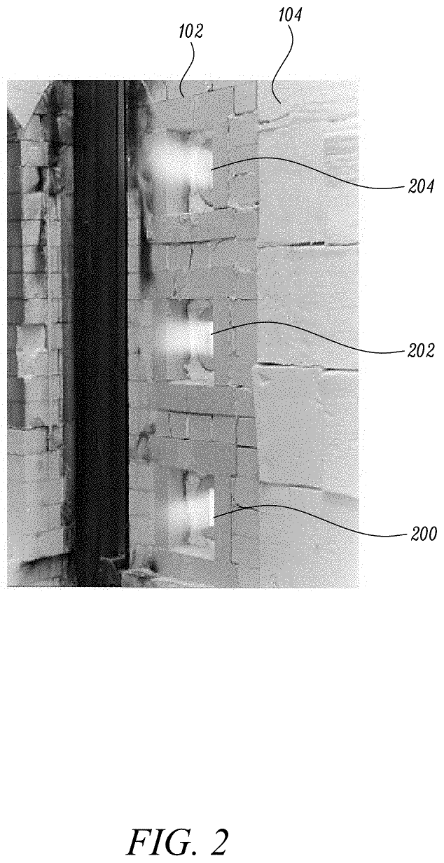

FIG. 2 illustrates an arrangement of the burners 106 of the zone 102 in the kiln 100, according to an example implementation of the present subject matter. As shown in FIG. 2, the zone 102 includes three hollow spaces 200, 202, and 204 arranged vertically. These hollow spaces 200, 202, and 204 are provided with the burners 106 (not shown in FIG. 2) to direct the flames inside the kiln 100. The flames produced by the burners though the hollow spaces 200, 202, and 204 are produced in same direction.

As shown in FIG. 1, the burners 106 receive supply of fuel from a fuel source 108 through a first conduit 110. The first conduit 110 is horizontally aligned over the wall 104. The supply of fuel from the first conduit 110 is distributed to each burner 106 of each zone 102 through a plurality of first channels 112-1, 112-2, 112-3, . . . , 112-N coupled to the first conduit 110 at respective openings 114-1, 114-2, 114-3, . . . , 114-N provided in the first conduit 110. The first channels 112 are arranged vertically and parallel to the vertically aligned burners 106. The first channels 112 receive supply of fuel from the respective openings 114 of the first conduit 110. The burners 106 are coupled to the first channels 112 through a first set of connectors 116. The first channels 112 facilitate supply of fuel to the burners 106 through the first set of connectors 116. In an implementation, the fuel may be a natural gas or any other gaseous fuel for example propane, butane, etc. Thus, fuel is alternatively referred to as gas hereinafter. Accordingly, the fuel source 108 may be alternatively referred to as gas source.

Further, the burners 106 receive supply of air from an air source 118 to support combustion. The burners 106 receive the supply of air through a second conduit 120. The second conduit 120 is horizontally aligned over the wall 104. The supply of air from the second conduit 120 is distributed to each burner 106 of each zone 102 through a plurality of second channels 122-1, 122-2, 122-3, . . . , 122-N coupled to the second conduit 120 at respective openings 124-1, 124-2, 124-3, . . . , 124-N provided in the second conduit 120. The second channels 122 are arranged vertically and parallel to the vertically aligned burners 106. The second channels 122 receive air form their respective openings 124 of the second conduit 120. The burners 106 are coupled to the second channels 122 through a second set of connectors 126. The second channels 122 supply air to the burners 106 through the second set of connectors 126. In an implementation, the air source 118 may be a blower or an exhaust fan blowing air in the second conduit 120 at a flow rate sufficient to maintain a desired combustion ratio of air and gas at each burner 106.

The first channels 112 are coupled to the first conduit 110 though gas dampers 128-1, 128-2, 128-3, . . . , 128-N. Similarly, the second channels 122 are coupled to the second conduit 120 through air dampers 130-1, 130-2, 130-3, . . . , 130-N. The gas dampers 128 control flow of gas volume from the first conduit 110 to the first channels 112. The air dampers 130 control flow of air volume from the second conduit 120 to the second channels 122. As shown in FIG. 1, the gas dampers 128 and the air damper 130 are individually provided for each of the zones 102, such that each zone 102 has a pair of a gas damper 128 and an air damper 130 for supplying gas and air to the burners 106.

The gas damper, for example 128-1, controls the flow of gas to the first channel 112-1 by operating a valve. When the valve in the gas damper 128-1 is closed, there is no flow of gas to the first channel 112-1 from the first conduit 110. When the gas damper 128-1 receives an actuating/valve opening signal, the gas damper 128-1 opens the valve to allow flow of gas to the first channel 112-1 from the first conduit 110. The amount of flow of gas to the first channel 112-1 is proportional to the opening of valve in the gas damper 128-1. The other gas dampers also work in the similar manner

The air damper, for example 130-1, controls the flow of air to the second channel 122-1 by operating a valve. When the valve in the air damper 130-1 is closed, there is no flow of air to the first channel 112-1 from the second conduit 120. When the air damper 130-1 receives an actuating/valve opening signal, the air damper 130-1 opens the valve to allow flow of air to the second channel 122-1 from the second conduit 120. The amount of flow of air to the second channel 122-1 is proportional to the opening of valve in the air damper 130-1. The other air dampers also work in the similar manner

In an example implementation, the gas dampers 128 and the air dampers 130 are damper actuators which operate on 4-20 mA supply.

Each zone 102 in the kiln 100 has a symmetrical arrangement of the burners 106. For example, a first zone 102-1 and a second zone 102-2 on the wall 104 have a first set and a second set of burners 106. A first row of burners 106-1 in the first set and the second set of burners 106 are arranged at similar heights with respect to the base 107. Similarly, a second row of burners 106-2 in the first set and the second set of burners 106 are arranged at similar heights with respect to the base 107 and above the first row of burners 106-1. Following this symmetrical arrangement, a third row of burners 106-3 in the first set and the second set of burners 106 are arranged at similar heights with respect to the base 107 and above the second row of burners 106-2. This symmetry of burners 106 maintains heating temperature in equal proportion in all the zones 102 of the kiln 100.

Further, arrangement of the supply of gas and the supply of air in each zone 102 through the first channel 112 and the second channel 122 are also symmetrical. For example, the first zone 102-1 has an arrangement of the first channel 112-1 and an arrangement of the second channel 122-1. Said arrangements of the first channel 112-1 and the second channel 122-1 are mirror images of one another. Similarly, other zones, such as, 102-2 and 102-3, have arrangements of the first channels 112-2 and 112-3 and arrangements of the second channels 122-2 and 120-3 are mirror image of each other, respectively. The symmetry of the arrangement of the first channels 112 and the arrangement of the second channels 122 with respect to each other maintain supply of similar ratio of gas and air to the burners 106 of different zones 102.

Further, such symmetry of burners 106 between the zones 102 and symmetry of arrangement for supply of gas and air maintain similar combustion ratio of air and gas among burners of different zones. Further, such overall symmetry enables maintain better heat balance in each zone.

The kiln 100 includes PID controllers 132-1, 132-2, 132-3, . . . , 132-N provided respectively for the zones 102. The gas dampers 128 and the air dampers 130 of each zone 102 are coupled to their respective PID controllers 132. The PID controllers 132-1, 132-2, 132-3, . . . , 132-N, control supply of gas and air to the burners 106 of zones 102 based on a predetermined firing ratio information. The firing ratio information is indicative of flow of amount gas and flow of amount of air to be supplied to the burners 106 of each of 102. Each pair of gas damper and air damper in a zone is controlled by a corresponding PID controller.

The PID controllers 132 determine a predetermined amount of flow of gas and a predetermined amount of flow of air to be supplied to each zone based on the predetermined firing ratio information. Accordingly, the PID controllers 132 control the gas dampers 128 and the air dampers 130 based on the predetermined amount of flow of gas and the predetermined amount of flow of air, respectively.

For example, a pair of the gas damper 128-1 and the air damper 130-1 in the zone 102-1 is controlled by a PID controller 132-1. The PID controller 132-1 sends signals to the gas damper 128-1 and the air damper 130-1 to open valves at predetermined percentages to allow the predetermined amount of flow of gas and air, respectively, to the burners 106 of the zone 102-1. In return, the PID controller 132-1 receives feedback indicating whether the valve opening percentage of the gas damper 128-1 and the air damper 130-1 are sufficiently allowing the predetermined amount of flow of gas in the first channel 112-1 and air in the second channel 122-1, respectively. Accordingly, the PID controller 132-1 determines whether the valves of the gas damper 128-1 and the air damper 130-1 are opened at predetermined percentages.

Gas flow sensors are provided for the first channels 112 of each zone 102 to detect amount of flow of gas in the first channels 112 and to provide feedback signals to the respective PID controllers 132 of the corresponding zones 102. The feedback signals by the gas flow sensors are the measurement values of the detect amount of flow of gas. Air flow sensors are provided for the second channels 122 of each zone 102 to detect amount of flow of gas in the second channels 122 and provide feedback signals to the respective PID controllers 132 of the corresponding zones 102. The feedback signals by the air flow sensors are the measurement values of the detect amount of flow of air.

Therefore, a gas flow sensor in the first channel 112-1 provides a feedback to the PID controller 132-1 about the amount of flow of gas in the first channel 112-1 which indicates whether the valve of the gas damper 128-1 is opened at the predetermined percentage to allow flow the predetermined amount of gas to the first channel 112-1. When the PID controller 132-1 determines from the feedback signal that the amount of flow of gas of being supplied to the first channel 112-1 is in excess or is lower than the predetermined amount of flow of gas, the PID controller 132-1 may send another signal to the gas damper 128-1 to readjust the valve to adjust flow of gas in the first channel 112-1 at the predetermined amount of flow of gas.

Alternatively, the gas dampers 128 may have inbuilt gas flow sensor to measure the amount of flow of gas in the first channels 112. Accordingly, the gas dampers 128 may provide feedback to the respective PID controllers 132 to about the amount of flow of gas in the first channels 112 in response to the opening the valve.

Further, an air flow sensor in the second channel 122-1 provides a feedback to the PID controller 132-1 about the amount of flow of air in the second channel 122-1 which indicate whether the valve of the air damper 130-1 is opened at predetermined percentage to allow flow the predetermined amount of air to the second channel 122-1. When the PID controller 132-1 determines from the feedback signal that the amount of flow of air of being supplied to the second channel 122-1 is in excess or is lower than the predetermined amount of flow of air, the PID controller 132-1 may send another signal to the air damper 130-1 to readjust the valve to adjust the flow of air in the second channel 122-1 at the predetermined amount of flow of air.

Alternatively, the air dampers 130 may have inbuilt air flow sensor to measure the amount of flow of air in the second channels 122. Accordingly, the air dampers 130 may provide feedback to the respective PID controllers 132 about the amount of flow of air in the second channels 122 in response to the opening the valve.

Each of the zones 102 in the kiln 100 includes a temperature sensor, a pressure sensor, a flame detector, a carbon monoxide (CO) sensor, and an oxygen sensor. In an example implementation, the kiln 100 may have a pressure sensor, a carbon monoxide (CO) sensor, and an oxygen sensor common for all the zones 102.

The temperature sensors are provided on a wall (not shown in figures) opposite to the wall 104. The temperature sensors measure the temperature of their respective zones 102 and provides the temperature measurement values to PID controllers 132 of respective zones 102. For example, a temperature sensor in the zone 102-1 measure the temperature and provides the temperature measurement value to the corresponding PID controller 132-1. The burners 106 in the zones 102 have heat output in one direction. Therefore, temperature measurement on the wall opposite to the wall 104 full-fills the burner symmetry.

The pressure sensor measures the atmospheric pressure in a corresponding zone and provide the measurement value to the corresponding PID controller. In case of a single pressure sensor, the pressure sensor may measure overall pressure in the kiln 100 and provide the measurement value to all the PID controllers 132.

The flame detector determiners whether the burner is working and provides a feedback to the PID controller. The carbon monoxide sensor (CO sensor) measures the level of carbon monoxide in a corresponding zone and provides the measurement value to the corresponding PID controller. Similarly, the oxygen sensor measures the level of oxygen in a corresponding zone and provides the measurement value to the corresponding PID controller. Alternatively, when a single CO sensor and a single oxygen sensor is provided in the kiln 100, the CO sensor and the oxygen sensor may measure overall levels of carbon monoxide and oxygen, respectively, and provide the measurement values to all the PID controllers 132.

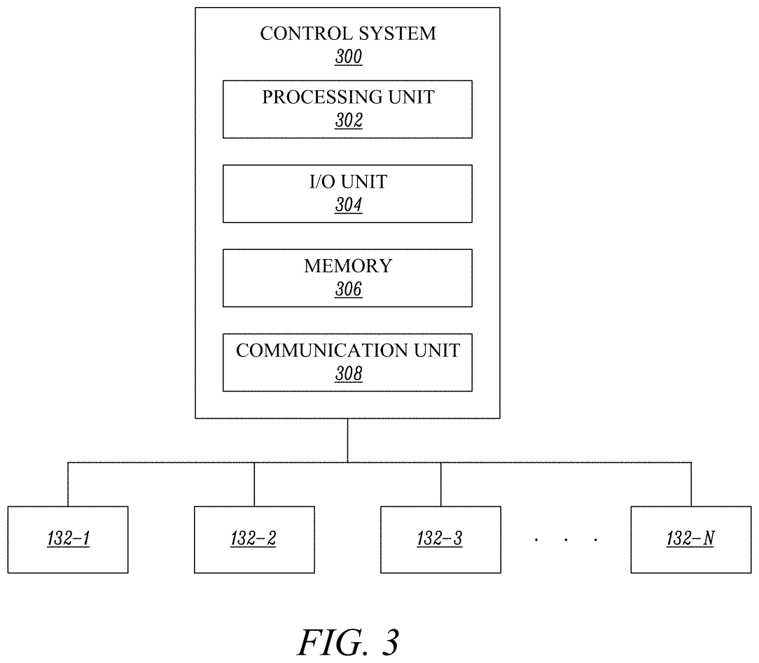

Further, the kiln 100 includes a control system 300. FIG. 3 illustrates the control system 300 implemented for firing the insulator, according to an example implementation of the present subject matter. The control system 300 includes a processing unit 302, an Input/Output unit, hereinafter referred to as I/O unit 304, a memory 306, and a communication unit 308.

The processing unit 302 may be implemented as microprocessors, microcomputers, microcontrollers, programmable logic controller, digital signal processors, central processing units, state machines, logic circuitries, and/or any devices that manipulate signals based on operational instructions. The memory 306 may be Random Access Memory (RAM) or Read Only Memory (ROM). The control system 300 further comprises a storage device, which may be a hard-disk drive or a removable storage drive, such as, a floppy-disk drive, optical-disk drive, and the like. The storage device may also be a means for loading computer programs or other instructions into the control system 300.

The processing unit 302 determines kiln firing parameters according to the firing stages of the firing process. The processing unit 302 communicates with the PID controllers 132-1, 132-2, 132-3, . . . , 132-N via the communication unit 308 through wired or wireless interface.

According to the present subject matter, the firing process involves different stages of heating which is in the order of preheating, oxidation, reduction, soaking, and cooling. The processing unit 302 determines the firing ratio information for the zones 102. The firing ration information includes various parameters which may include temperature, amount of flow of gas, amount of flow of air, oxygen level, carbon monoxide level, pressure, etc. The firing ratio information indicates a predetermined amount of flow of gas and a predetermined amount of flow of air to be supplied to each zone 102 of the kiln 100 during the firing process. The values of parameters in the firing ratio information changes with time as the firing stage progress from one to another.

The values of parameters in the firing ratio information may also change with time even within a single stage of firing process. For example, in the oxidation stage, the firing ratio information indicates that the predetermined amount of flow of gas is X₁ and the predetermined amount of air is Y₁ when the temperature required inside the kiln 100 to be 800 degree centigrade when 40 hours has elapsed from the starting of the firing process. Further, the firing ratio information may indicate that the predetermined amount of flow of gas is X₂ and predetermined amount of air is Y₂ when the temperature required inside the kiln 100 to be 900 degree centigrade when 42 hours has elapsed from staring of the firing process.

The processing unit 302 determines firing ratio information based on the parameters, such as, an instantaneous temperature required in the kiln, standard ratio of gas with respect to air, amount of flow of gas, and amount of flow of air. Thereafter, the processing unit 302 shares the firing ratio information with the PID controllers 132. Parameters in the firing ratio information includes details of temperature required in the kiln, a predetermined amount of flow of gas, and a predetermined amount of flow of air. In an example implementation, the firing ratio information may also include details of pressure to be maintained inside the kiln, amount of carbon monoxide required inside the kiln, and amount of oxygen required inside the kiln. Based on the firing ratio information, the PID controllers 132 control supply of gas and air to the three burners 106 of the zones 102.

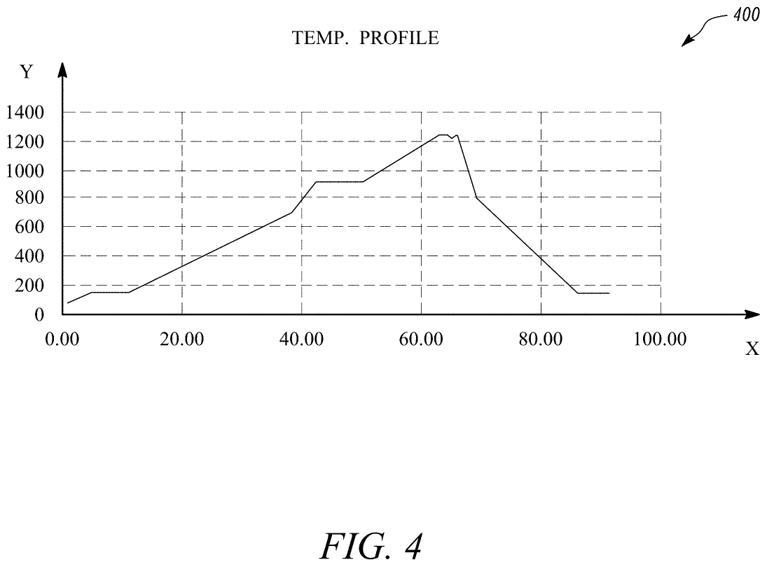

FIG. 4 illustrates a temperature profile chart 400, according to an example implementation of the present subject matter. The temperature profile chart 400 illustrates the different stages of firing process through which the electro porcelain insulator may pass. The temperature profile chart 400 has X-axis representing time (hours) and Y-axis representing the temperature (degree centigrade). As shown in FIG. 4, the cycle time for firing the electro porcelain insulator is around 96 hours, where the temperature reaches up to 1280 degree centigrade. Thereafter, the insulator is cooled down to 150 degree centigrade.

The temperature profile is provided to the control system 300 through the I/O unit 304 or a plurality of temperature profiles are stored in the memory 306. A user selects a temperature profile though I/O unit. Accordingly, the processing unit 302 determines instantaneous temperature from the temperature profile. The temperature profile is indicative of rate of change in temperature according to the firing process. The instantaneous temperature is based on the time lapsed during the firing process. Based on the instantaneous temperature and the time elapsed, the processing unit 302 determines amount of flow of gas and air to the burners 106 of the zones 102 and provides the firing ratio information to the PID controllers 132 to control amount of supply of gas and air to the burners 106 of respective zones 102. Further, based on the time lapsed the processing unit 302 may determine further parameters, such as, pressure, carbon monoxide, and oxygen and shares these parameters with the PID controllers 132.

For example, referring to the temperature profile chart 400, at time 30 hours, the processing unit 302 determines that the firing process is at the oxidation stage and the instantaneous temperature required inside the kiln 100 is 500 degree centigrade. Further, the processing unit 302 determines that the predetermined amount of flow of air is 350 cubic meters/hour. Furthermore, the processing unit 302 determines that the predetermined amount of flow of gas is 35 cubic meters/hours when the standard ratio of air to gas is 10:1.

Further, at time 50 hours, the processing unit 302 determines that the firing process is entered into the reduction stage and the instantaneous temperature required inside the kiln 100 is 1000 degree centigrade. Further, the processing unit 302 determines that the predetermined amount of flow of air for the reduction stage at 52.5 hours to be 305 cubic meters/hour. Accordingly, the processing unit 302 determines that the predetermined amount of flow of gas to be 43.57 cubic meters/hours when the standard ratio of air to gas is 7:1.

The PID controllers 132 receive the firing ratio information from the processing unit 302. Based on the firing ratio information the PID controllers 132 control the amount of flow of gas and air to the burners of respective zones 102. The firing ratio information may include one or more following parameters:
a predetermined temperature,
a predetermined amount of flow of gas,
a predetermined amount of flow of air,
a pressure value,
carbon monoxide value, and
oxygen value.

The PID controllers 132 work in closed look feedback system and receives feedback from the gas dampers 126, the air dampers 128, and all the sensors, as mentioned previously. Based on the feedback, the PID controllers 130 maintains parameters as indicated by the firing ratio information inside the kiln 100.

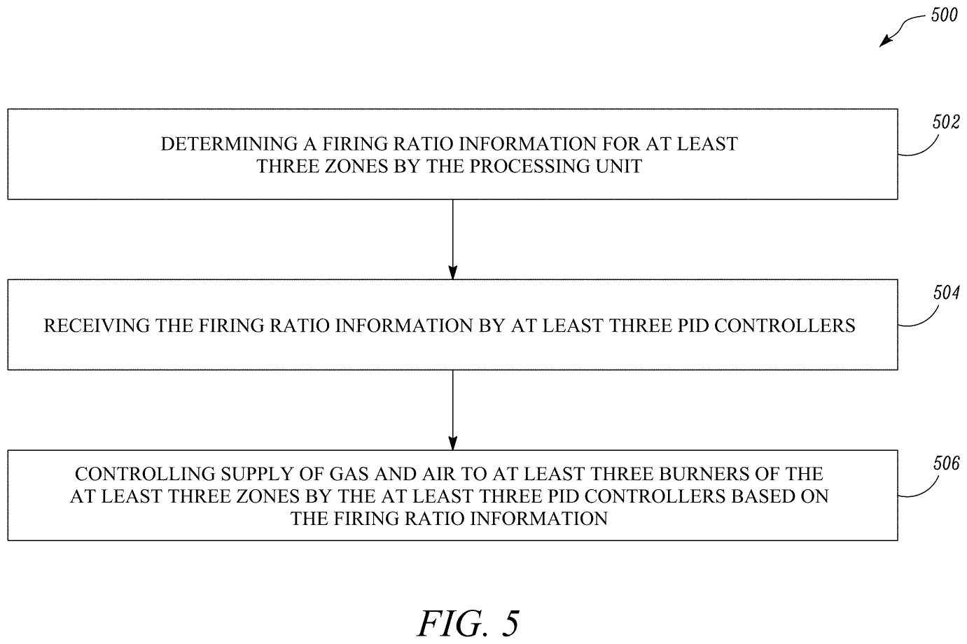

FIG. 5 illustrates a method 500 for firing an insulator, according to an example implementation of the present subject matter. At step 502, a firing ratio information is determined by the processing unit 302 for the burners 106 of at least three zones 102. The at least three zones 102 are provided on the wall 104 of the kiln 100. Each zone of the at least three zones 102 has at least three burners arranged vertically.

At step 504, the firing ratio information determined by the processing unit 302 is received by at least three PID controllers 132 from the processing unit 302. Each zone of the at least three zones 102 has an associated PID controller from the at least three PID controllers 132.

At step 506, supply of gas and air to the at least three burners of the at least three zones are controlled by the at least three PID controller 132 based on the firing ratio information. Each of the at least three PID controllers 132 controls supply of air and gas to the at least three burners of a corresponding zone 102.

For controlling the supply of gas and air to the at least three burners of each zone based on the firing ratio information, a predetermined amount of flow of gas and a predetermined amount of flow of air to be supplied to a corresponding zone of the at least three zones based on the firing ratio information is determined by each of the PID controller 132. Thereafter, the gas dampers 128 are controlled by the corresponding PID controllers 132 to allow the predetermined flow of gas to the at least three burners 106 of the corresponding zone 102 where the gas dampers 128 are individually provided for each zone of the at least three zones 102. The air dampers 130 are controlled by the corresponding PID controllers 132 to allow the predetermined flow of air to the at least three burners 106 of the corresponding zone 102 where the air dampers 130 are individually provided for each zone of the at least three zones 102.

With the systems and methods of the present subject matter precise control of internal atmosphere of the kiln 100 is obtained. With precise control, a smooth change in temperature and smooth transformation of firing stage is also obtained. As a result, fuel consumption is reduced. A comparison between input metrices of a conventional kiln and the kiln 100, having three zones where each zone has three burners, is shown in Table 1 below.

TABLE 1

| | Quantity | Quantity |
|---|---|---|
| | (Conventional | (Kiln of present |
| Particular | Kiln) | subject matter) |
| Kiln defect | 0.40% | 0.12% |
| Specific Fuel Consumption | 0.355 | 0.330 |
| (SFC) | | |
| Per cycle consumption | 4.04 | 3.80 |
| Average loading/cycle | 11.38 | 11.50 |
| (Metric Ton) | | |
| Loading/month | 87 | 92 |
| (Metric Ton) | | |
| Savings in percentage | — | 6.935% |
| (SFC) | | |

As shown in Table 1, with precise control of internal atmosphere of the kiln the fuel consumption is reduced by 7 percent approximately. Further, with smooth transition in firing stages the rejection rate of finished insulators is reduced.

While aspects of the present disclosure have been particularly shown, and described with reference to the embodiments above, it will be understood by those skilled in the art that various additional embodiments may be contemplated by the modification of the disclosed machines, systems, and methods without departing from the spirit and scope of what is disclosed. Such embodiments should be understood to fall within the scope of the present disclosure as determined based upon the claims and any equivalents thereof.

We claim:

1. A kiln for firing an insulator, the kiln comprising:
at least three zones on a wall of the kiln, wherein each of the at least three zones have at least three burners arranged vertically;
a processing unit to determine a firing ratio information for the at least three zones; and
at least three proportional-integral-derivative (PID) controllers, coupled to the processing unit, to control supply of gas and air to the at least three burners of the at least three zones based on the firing ratio information, wherein each of the PID controllers corresponds to a zone of the at least three zones.

2. The kiln as claimed in claim 1, wherein supply of gas from a gas source is distributed to the at least three burners of the at least three zones through gas dampers, and wherein supply of air from an air source is distributed to the at least three burners of the at least three zones through air dampers.

3. The kiln as claimed in claim 2, wherein the at least three PID controllers are to:
receive firing ratio information from the processing unit;
determine a predetermined amount of flow of gas and a predetermined amount of flow of air to be supplied to the at least three burners of the corresponding zones based on the firing ratio information;
control the gas dampers, individually provided for each zone of the at least three zones, to supply the predetermined amount of flow of gas to the at least three burners of the corresponding zones; and
control the air dampers, individually provided for each zone of the at least three zones, to supply the predetermined amount of flow of air to the at least three burners of the corresponding zones.

4. The kiln as claimed in claim 2, wherein an arrangement of supply of gas and an arrangement of supply of air to the at least three burners of the at least three zones are symmetrical with respect to each other.

5. The kiln as claimed in claim 1, wherein each of the at least three PID controllers maintains, during firing, parameters inside the kiln as indicated in the firing ratio information in a corresponding zone based on at least one of the following parameters:
temperature of each zone of the at least three zones;
flow of air to each zone of the at least three zones;
flow of gas to each zone of the at least three zones;
pressure of the kiln;
flame detection;
amount of carbon monoxide; and
amount of oxygen.

6. A method for firing an insulator in a kiln, the method comprising:
determining, by a processing unit, a firing ratio information for at least three zones, wherein the at least three zones are provided on a wall of the kiln and wherein each zone has at least three burners arranged vertically;
receiving, by at least three proportional-integral-derivative (PID) controllers, firing ratio information from the processing unit; and
controlling, by the at least three PID controllers, supply of gas and air to the at least three burners of the at least three zones based on the firing ratio information, wherein each of the at least three PID controllers controls supply of air and gas to the at least three burners of a corresponding zone of the at least three zones.

7. The method as claimed in claim 6, wherein supply of gas from a gas source is distributed to the at least three burners of the at least three zones through gas dampers, and wherein supply of air from an air source is distributed to the at least three burners of the at least three zones through air dampers.

8. The method as claimed in claim 7, wherein controlling supply of air and gas to the at least three burners of the at least three zones, based on the firing ratio information, comprises:
determining, by the at least three PID controllers, a predetermined amount of flow of gas and a predetermined amount of flow of air to be supplied to the at least three burners of the corresponding zones based on the firing ratio information;
controlling, by the at least three PID controllers, the gas dampers, individually provided for each zone of the at least three zones, to allow the predetermined flow of gas to the at least three burners of the corresponding zone; and
controlling, by the at least three PID controllers, the air dampers, individually provided for each zone of the at least three zones, to allow the predetermined flow of air to the at least three burners of the corresponding zone.

9. The method as claimed in claim 7, wherein an arrangement of supply of air and an arrangement of supply of gas to the at least three burners of the at least three zones are symmetrical with respect to each other.

10. The method as claimed in claim 6, wherein the method comprises maintaining, by each of the PID controllers in the corresponding zone, parameters inside the kiln as indicated in the firing ratio information based on at least one the following parameters:
temperature of each zone of the at least three zones;
flow of air to each zone of the at least three zones;
flow of gas to each zone of the at least three zones;
pressure of the kiln;
flame detection;
amount of carbon monoxide; and
amount of oxygen.
